(19) United States
(12) Patent Application Publication
(10) Pub. No.: US 2023/0156133 A1
(43) Pub. Date: May 18, 2023

(54) IMAGE FORMING APPARATUS, POST-PROCESSING POSITION ADJUSTING METHOD AND NON-TRANSITORY COMPUTER-READABLE MEDIUM ENCODED WITH POST-PROCESSING POSITION ADJUSTING PROGRAM

(71) Applicant: KONICA MINOLTA, INC., Tokyo (JP)

(72) Inventor: Ryo MORITA, Toyohashi (JP)

(21) Appl. No.: 17/974,500

(22) Filed: Oct. 26, 2022

(30) Foreign Application Priority Data
Nov. 18, 2021 (JP) 2021-188080

(51) Int. Cl. H04N 1/028; H04N 1/00

(52) U.S. Cl. CPC H04N 1/02885; H04N 1/00771; H04N 1/00726; H04N 1/00639

(57) ABSTRACT

An image forming apparatus includes a post-processing device that folds a paper on which an image is formed, a document scanner that scans a document, and a hardware processor. The hardware processor acquires image data output by the document scanner scanning a region that includes a contour of the document with a folding line formed by being folded by the post-processing device, and determines a relative position of the contour and the folding line of the document based on the image data.

The entire disclosure of Japanese Patent Application No. 2021-188080 filed on Nov. 18, 2021, is incorporated herein by reference in its entirety.

### BACKGROUND

### Technological Field

The present invention relates to an image forming apparatus, a post-processing position adjusting method, and a non-transitory computer-readable medium encoded with a post-processing position adjusting program. In particular, the present invention relates to an image forming apparatus that includes a function of processing a paper, a post-processing position adjusting method performed by the image forming apparatus, and a non-transitory computer-readable recording medium encoded with a post-processing position adjusting program that causes a computer that controls the image forming apparatus to execute the post-processing position adjusting method.

### Description of the Related Art

A post-processing device that processes a paper on which an image is formed by a multiple function apparatus such as an MFP (a Multiple Function Peripheral) is known. The process of a paper includes a processing of folding the paper. Adjustment of a position where the paper is folded is required in this post-processing device. JP 2016-158113 A describes an image scanning device that includes a transparent plate on which a document is arrangeable, a first light emitter that is positioned in one of regions divided by a first plane perpendicular to a scanning surface for scanning an image of the document below the transparent plate and emits light from an oblique direction to a scanning position at which the image of the document is scanned, a second light emitter that is positioned in the other of the regions divided by the first plane below the transparent plate and emits light from the oblique direction to the scanning position at which the image of the document is scanned, a light receiver capable of receiving reflected light of the lights emitted to the image of the document by both of the first light emitter and the second light emitter, a first image information acquirer that receives the reflected light of the lights emitted to the document by both of the first light emitter and the second light emitter and acquires first image information of the document, a second image information acquirer that receives the reflected light of the light emitted to the document by the first light emitter and acquires second image information of the document, a third image information acquirer that receives the reflected light of the light emitted to the document by the second light emitter and acquires third image information of the document, and a folding line information deriving unit that derives information of a folding line of the document from the acquired first image information, second image information and third image information.

In the image scanning device described in JP 2016-158113 A, a position of the folding line in the image information obtained by scanning the document can be detected, but unless the document is accurately positioned on the transparent plate, the position of the folding line in the document cannot be accurately detected. While the document with the folding line is unfolded, the document is not flat at the folding line. As such, in a case where the unfolded document is placed on the transparent plate, a relative position of the paper to the transparent plate is sometimes deviated and, therefore, it is difficult to accurately position the document on the transparent plate.

### SUMMARY

In order to achieve the above-described object, according to one aspect of the present invention, an image forming apparatus includes a post-processing device that folds a paper on which an image is formed, a document scanner that scans a document, and a hardware processor that acquires image data output by the document scanner scanning a region that includes a contour of the document with a folding line formed by being folded by the post-processing device, and the hardware processor determines a relative position of the contour and the folding line of the document based on the image data.

According to another aspect of the present invention, a post-processing position adjusting method is performed by an image forming apparatus including a post-processing device that folds a paper on which an image is formed, the image forming apparatus further including a document scanner that scans a document. The method includes: a scan controlling step of acquiring image data output by the document scanner scanning a region that includes a contour of the document with a folding line formed by being folded by the post-processing device; and a relative position determining step of determining a relative position of the contour and the folding line of the document based on the image data.

According to still another aspect of the present invention, a non-transitory computer-readable recording medium is encoded with a post-processing position adjusting program executed by a computer that controls an image forming apparatus that includes a post-processing device that folds a paper on which an image is formed, the image forming apparatus further includes a document scanner that scans a document, and the post-processing position adjusting program causes the computer to execute: a scan controlling step of acquiring image data output by the document scanner scanning a region that includes a contour of the document with a folding line formed by being folded by the post-processing device; and a relative position determining step of determining a relative position of the contour and the folding line of the document based on the image data.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a front view of an image forming apparatus in one of embodiments of the present invention;

FIG. 2 is a schematic cross-sectional view showing one example of an inner configuration of a main body of an MFP;

FIG. 3 is a diagram showing an inner configuration of a post-processing device;

FIG. 4 is a first diagram for explaining threefold processing performed by a second mechanism;

FIG. 5 is a second diagram for explaining the threefold processing performed by the second mechanism;

FIG. 6 is a third diagram for explaining the threefold processing performed by the second mechanism;

FIG. 7 is a first diagram for explaining Z-fold processing performed by a first mechanism;

FIG. 8 is a second diagram for explaining the Z-fold processing performed by the first mechanism;

FIG. 9 is a block diagram showing the outline of a hardware configuration of the MFP;

FIG. 10 is a block diagram showing one example of functions of a CPU included in the MFP;

FIG. 11 is a diagram showing one example of synthetic data;

FIG. 12 is a diagram showing one example of difference data;

FIG. 13 is a diagram showing one example of a correction amount adjustment screen;

FIG. 14 is a flowchart showing one example of a flow of image forming processing;

FIG. 15 is a flowchart showing one example of a flow of output image scanning processing;

FIG. 16 is a flowchart showing one example of a flow of post-processing position adjustment processing; and

FIG. 17 is a diagram showing one example of a correction amount adjustment screen in a modification.

### DETAILED DESCRIPTION OF EMBODIMENTS

Hereinafter, one or more embodiments of the present invention will be described with reference to the drawings. However, the scope of the invention is not limited to the disclosed embodiments.

An image forming apparatus in embodiments of the present invention will be described below by way of example of an MFP (Multi Function Peripheral) with reference to the drawings. In the following description, the same parts are denoted with the same reference characters. Their names and functions are also the same. Thus, a detailed description thereof will not be repeated.

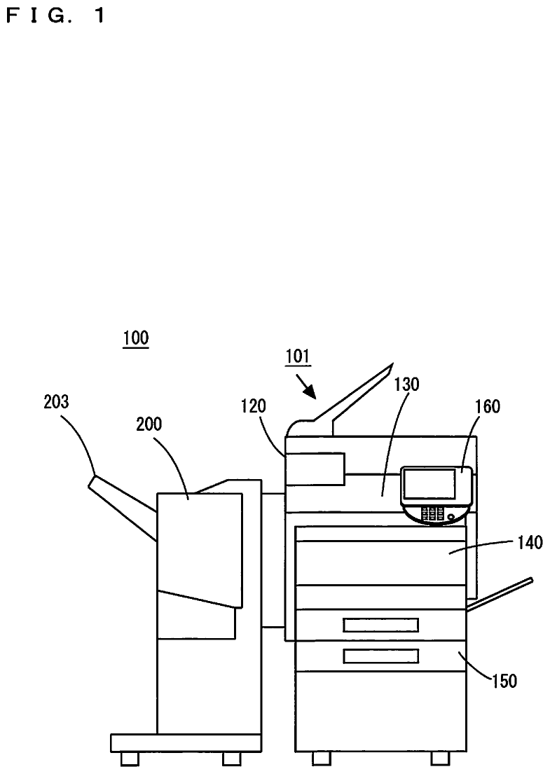

FIG. 1 is a front view of an MFP in one of the embodiments of the present invention. With reference to FIG. 1, an MFP 100 functions as an image forming apparatus and includes a main body 101 and a post-processing device 200. The main body 101 includes a document scanner 130 for scanning a document, an automatic document feeder 120 for conveying a document to the document scanner 130, an image former 140 for forming an image on a recording medium based on image data output by the document scanner 130 that scans the document, a paper feeder 150 for supplying the recording medium to the image former 140, and an operation panel 160 serving as a user interface. The main body 101 can form an image on any of a plurality of types of recording mediums as targets on which the image is formed The recording mediums include a sheet of paper, an OHP (overhead projector) sheet, a cloth, etc. In the following description, a case where a paper is used as the recording medium is described by way of example unless otherwise mentioned.

A paper with an image formed thereon is supplied from the main body 101 to the post-processing device 200. The post-processing device 200 includes a folding mechanism as a mechanism that processes the paper. The folding mechanism performs a processing of folding one paper or a stack of papers at a predetermined position. The post-processing device 200 performs three types of folding processing depending on different folding positions and directions. The three types of folding processing includes a center-fold processing of folding a paper at its center, a threefold processing of folding a paper by valley-folding the paper at two folding lines that trisect the paper, and a Z-fold processing of folding a paper by mountain-folding the paper at one of two folding lines that trisect the paper and valley-folding the paper at the other folding line. Also, the post-processing device 200 includes a staple mechanism that performs a processing of stapling a stack of a plurality of papers. Furthermore, the post-processing device 200 may include a sorting mechanism that performs a processing of sorting and discharging one or more papers on which images are formed by the MFP 100, and a hole-punching process mechanism that performs a processing of punching the papers.

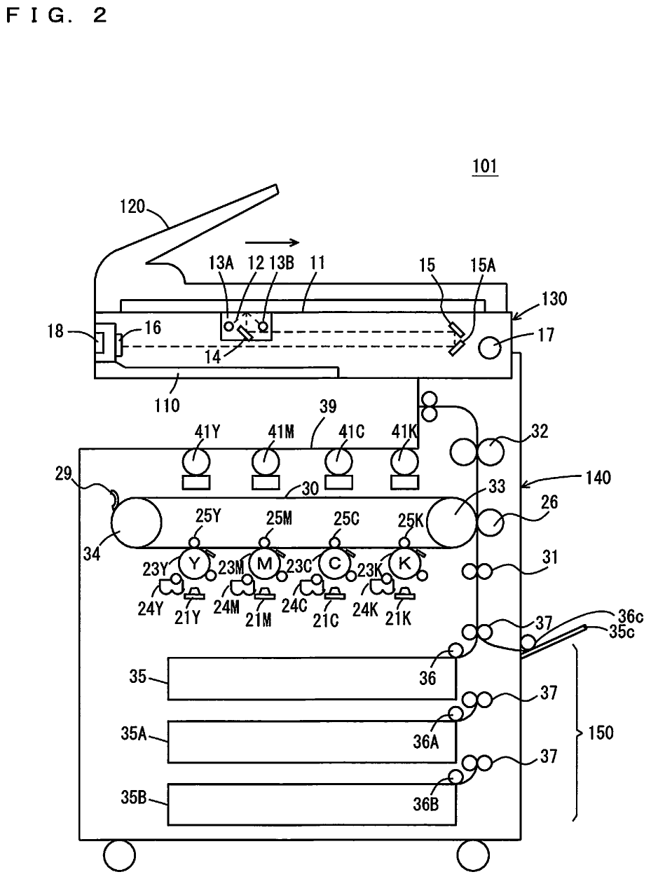

FIG. 2 is a schematic cross-sectional view showing one example of an inner configuration of the main body of the MFP. With reference to FIG. 2, the document scanner 130 has a rectangular scanning surface for scanning a document. The scanning surface is formed of a platen glass, for example, and is arranged horizontally. The automatic document feeder 120 is connected to the main body of the MFP 100 to be rotatable about an axis parallel to one side of the scanning surface and is openable and closable. The document scanner 130 is arranged below the automatic document feeder 120, and the scanning surface of the document scanner 130 is exposed with the automatic document feeder 120 rotated and open. Thus, a user can place a document on the scanning surface of the document scanner 130. The automatic document feeder 120 can change between an open state in which the scanning surface of the document scanner 130 is exposed and a closed state in which the scanning surface is covered.

The document scanner 130 exposes an image of a document set on a document glass 11 by the automatic document feeder 120 using exposure lamps 13A, 13B attached to a slider 12 that moves in a sub-scanning direction indicated by the arrow in FIG. 2 below the document glass. The exposure lamps 13A, 13B each have a shape extending in a main scanning direction that is perpendicular to the sub-scanning direction. Light reflected from the document is led to a lens 16 by a mirror 14 and two reflection mirrors 15, 15A and forms an image on a CCD (Charge Coupled Devices) sensor 18.

The exposure lamps 13A, 13B are arranged in different positions in the sub-scanning direction of the document. The mirror 14 is arranged between the exposure lamps 13A and 13B in the sub-scanning direction. As such, with respect to light that reaches the mirror 14 due to exposure of each of the exposure lamps 13A, 13B, a first incidence angle at which light emitted from the exposure lamp 13A is incident on the document and a second incidence angle at which light emitted from the exposure lamp 13B is incident on the document are different from each other. In the sub-scanning direction, the exposure lamp 13A is positioned on a minus side with respect to the mirror 14, while the exposure lamp 13A is positioned on a plus side with respect to the mirror 14. As such, in a case where there is a folding line that intersects with a scanning direction, each of the first incidence angle and the second incidence angle changes before and after the folding line. This change is different between the exposure lamp 13A and the exposure lamp 13B.

The CCD sensor 18 has a plurality of optoelectronic transducers arranged in the main scanning direction. The reflected light that forms the image on the CCD sensor 18 is converted into image data as an electrical signal in the CCD sensor 18. The image data is converted into printing data pieces of cyan (C), magenta (M), yellow (Y), and black (K) and is then output to the image former 140.

The image former 140 includes developing devices 24Y, 24M, 24C, 24K, photoreceptor drums 23Y, 23M, 23C, 23K, exposure units 21Y, 21M, 21C, 21K, first transfer rollers 25Y, 25M, 25C, 25K, and toner bottles 41Y, 41M, 41C, 41K corresponding to yellow, magenta, cyan and black, respectively. Here, “Y,” “M,” “C,” and “K” represent yellow, magenta, cyan, and black, respectively.

The only difference among the developing devices 24Y, 24M, 24C, 24K, the photoreceptor drums 23Y, 23M, 23C, 23K, the exposure units 21Y, 21M, 21C, 21K, the first transfer rollers 25Y, 25M, 25C, 25K, and the toner bottles 41Y, 41M, 41C, 41K is the colors of toner to be used. Therefore, the developing device 24Y, the photoreceptor drum 23Y, the exposure unit 21Y, the first transfer roller 25Y, and the toner bottle 41Y for forming a yellow image will now be described.

The toner bottle 41Y stores a yellow developer. A developer contains a non-magnetic toner and a magnetic carrier. The toner bottle 41Y is rotated by a toner bottle motor as a driving source to discharge the developer outside. The developer discharged from the toner bottle 41Y is supplied to the developing device 24Y. The toner bottle 41Y supplies the developer to the developing device 24Y in response to the remaining amount of the developer stored in the developing device 24Y reaching not more than a predetermined lower limit value.

An intermediate transfer belt 30 is suspended by a driving roller 33 and a driven roller 34 so as not to be loosened. When the driving roller 33 rotates in a counterclockwise direction in FIG. 2, the intermediate transfer belt 30 rotates at a predetermined speed in the counterclockwise direction in FIG. 2. The driven roller 34 rotates in the counterclockwise direction with the rotation of the intermediate transfer belt 30.

The developer is resupplied from the toner bottle 41Y to the developing device 24Y, and the developing device 24Y develops an electrostatic latent image formed on the photoreceptor drum 23Y, so that a toner image is formed on the photoreceptor drum 23Y. The toner image formed on the photoreceptor drum 23Y is transferred onto the intermediate transfer belt 30 by the first transfer roller 25Y. A time when the toner image is transferred onto the intermediate transfer belt 30 by the developing device 24Y is adjusted by detection of a reference mark provided on the intermediate transfer belt 30.

The MFP 100 drives all of the developing devices 24Y, 24M, 24C, 24K in the case of forming a full-color image. Thus, toner images in yellow, magenta, cyan and black are superimposed on the intermediate transfer belt 30. The MFP 100 drives any one of the developing devices 24Y, 24M, 24C, 24K in the case of forming a monochrome image. Also, two or more of the developing devices 24Y, 24M, 24C, 24K can be combined to form an image.

Papers of different sizes are set in paper feed cassettes 35, 35A, 35B, respectively. The papers stored in the paper feed cassettes 35, 35A, 35B are supplied to a conveying path by take-out rollers 36, 36A, 36B attached to the paper feed cassettes 35, 35A, 35B, respectively, and are then conveyed to a timing roller 31 by paper feed rollers 37.

The timing roller 31 conveys the papers conveyed by the paper feed rollers 37 to a nip portion located between the intermediate transfer belt 30 and a second transfer roller 26 as a transfer member. The second transfer roller 26 generates an electric field at the nip portion. By the action of electric field force at the nip portion, the toner image formed on the intermediate transfer belt 30 is transferred onto the paper conveyed by the timing roller 31. The paper, onto which the toner image has been transferred is conveyed to a fuser roller 32, heated and pressurized by the fuser roller 32. Thus, the toner is melted and fused to the paper. Thereafter, the paper is discharged onto a paper discharge tray 39. A belt cleaning blade 29 is provided upstream of the developing device 24Y of the intermediate transfer belt 30. The belt cleaning blade 29 removes the toner which has not been transferred onto the paper but remains on the intermediate transfer belt 30.

While an example is described in which the MFP 100 adopts a tandem system that includes the developing devices 24Y, 24M, 24C, 24K that respectively form toner of four colors on a paper, the MFP 100 may adopt a four cycle system in which toner of four colors are transferred onto a paper in sequence by one photoreceptor drum.

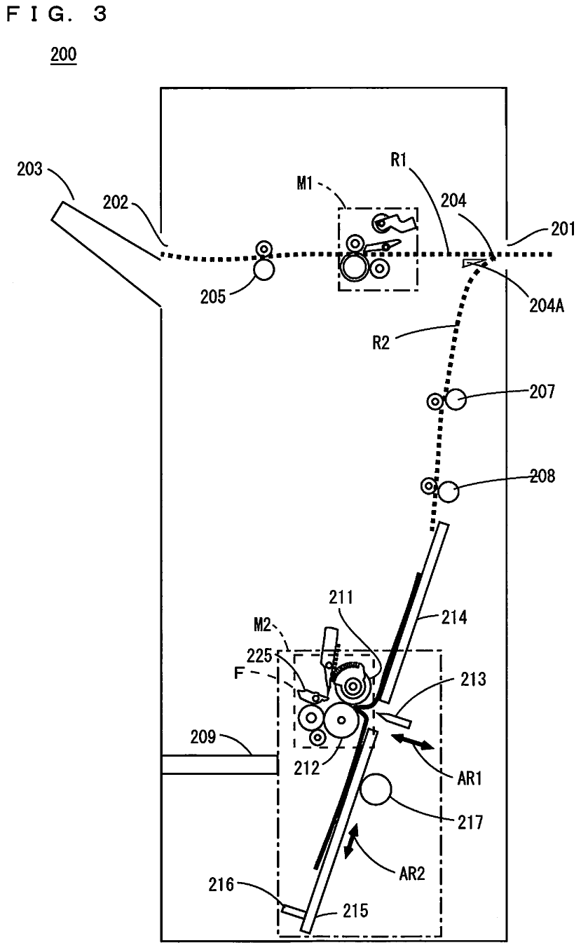

FIG. 3 is a diagram showing the inner configuration of the post-processing device 200. With reference to FIG. 3, the post-processing device 200 has a first mechanism M1 that performs a Z-fold processing and a second mechanism M2 that performs a center-fold processing and a threefold processing. The first mechanism M1 is a mechanism that performs the Z-fold processing of folding a paper by mountain-folding the paper at one of two folding lines that trisect the paper and valley-folding the paper at the other folding line so as to make the paper have a Z-shaped cross section. The second mechanism M2 is a mechanism that performs the center-fold processing of folding a paper by mountain-folding the paper at its center line and the threefold processing of folding a paper by mountain-folding the paper at two folding lines that trisect the paper so as to make a three-folded paper.

A first conveying path R1 is a paper conveying path that connects a paper receiving port 201 and a first discharge port 202. The paper receiving port 201, a branching point 204, the first mechanism M1, a conveying roller pair 205, and the first discharge port 202 are arranged in this order from an upstream of the first conveying path R1. The branching point 204 is provided between the paper receiving port 201 and the first mechanism M1 on the first conveying path R1. A switching guide 204A is disposed at the branching point 204.

A second conveying path R2 is a paper conveying path that connects the branching point 204 and the second mechanism M2. The branching point 204, the conveying roller pairs 207, 208, and the second mechanism M2 are arranged in this order from an upstream of the second conveying path R2.

A paper discharged from the main body 101 of the MFP 100 is received at the paper receiving port 201. In a case where it is set to perform the post-processing on a paper, the switching guide 204A switches the conveying path to the first conveying path R1, so that the paper received at the paper receiving port 201 is conveyed along the first conveying path R1 and is then discharged from the first discharge port 202 to the paper discharge tray 203 via the first mechanism M1 and the conveying roller pair 205. In a case where it is set to perform the Z-fold processing on a paper, the paper is conveyed along the first conveying path R1 and is subjected to the Z-fold processing in the first mechanism M1. The paper subjected to the Z-fold processing in the first mechanism M1 is discharged from the first discharge port 202 to the paper discharge tray 203 via the conveying roller pair 205.

In a case where it is set to perform the center-fold processing of folding the paper at the center line or to perform the threefold processing of folding the paper in three, the switching guide 204A switches the conveying path to the second conveying path R2. The paper conveyed from the paper receiving port 201 is conveyed to the branching point 204 through the first conveying path R1 and then enters the second conveying path R2. The paper that has entered the second conveying path R2 is conveyed to the second mechanism M2 by the conveying roller pairs 207, 208. The paper subjected to the center-fold processing and the Z-fold processing in the second mechanism M2 is discharged to a second discharge port 209 through above a threefold gate 225.

<Center-Fold Processing>

The center-fold processing is performed by the second mechanism M2. The second mechanism M2 includes a first center-fold roller 211, a second center-fold roller 212, a center-fold knife 213, an auxiliary tray 214, a stacking tray 215, a stopper 216, and a positioning motor 217.

The stacking tray 215 and the auxiliary tray 214 each have a stacking surface on which papers are stacked. The stacking surface is a plane surface. The stacking tray 215 and the auxiliary tray 214 are positioned such that the respective stacking surfaces of the stacking tray 215 and the auxiliary tray 214 are positioned within a same plane surface. The stacking tray 215 and the auxiliary tray 214 are each arranged to have its stacking surface inclined from vertical by a predetermined angle. The auxiliary tray 214 is arranged at a predetermined distance from the stacking tray 215 in a paper conveying direction. Papers conveyed through the second conveying path R2 are stacked on each of the stacking tray 215 and the auxiliary tray 214.

The stopper 216 is arranged at a lower end of the stacking tray 215. A leading end of a paper in the paper conveying direction abuts against the stopper 216, so that a position of the paper with respect to the stacking tray 215 is determined. The stopper 216 is connected to the stacking tray 215 so as to be movable along the paper conveying direction in parallel to the stacking surface of the stacking tray 215. The positioning motor 217 moves the stopper 216 on the stacking tray 215. The positioning motor 217 is a stepping motor and determines a relative position of the stopper 216 to the stacking tray 215. The positioning motor 217 determines the relative position of the stopper 216 and the stacking tray 215 based on a paper size. The relative position of the stopper 216 and the stacking tray 215 is determined with respect to a paper size. The positioning motor 217 also fine-adjusts the relative position of the stopper 216 and the stacking tray 215.

The center-fold knife 213, the first center-fold roller 211, and the second center-fold roller 212 are arranged between the auxiliary tray 214 and the stacking tray 215. A set of the first center-fold roller 211 and the second center-fold roller 212 is arranged opposite to the center-fold knife 213 with respect to the respective stacking surfaces of the auxiliary tray 214 and the stacking tray 215.

The first center-fold roller 211 and the second center-fold roller 212 are arranged opposite to each other. The first center-fold roller 211 has its rotation axis biased toward a rotation axis of the second center-fold roller 212. The center-fold knife 213 is arranged opposite to a center-fold portion where the first center-fold roller 211 and the second center-fold roller 212 are in contact with each other. The center-fold knife 213 is movable in a direction perpendicular to the respective stacking surfaces of the stacking tray 215 and the auxiliary tray 214 as indicated by the arrow AR1 and is moved by driving a driving motor.

With one or more papers stacked on the stacking tray 215 and the auxiliary tray 214, the center-fold knife 213 is moved toward the center-fold portion where the first center-fold roller 211 and the second center-fold roller 212 are in contact with each other. With the movement of the center-fold knife 213, one paper or a stack of papers stacked on the stacking tray 215 and the auxiliary tray 214 is pushed into the center-fold portion. Thus, the one paper or the stack of papers is drawn in by the first center-fold roller 211 and the second center-fold roller 212 and is mountain-folded. The stack of papers is discharged to the second discharge port 209 by the first center-fold roller 211 and the second center-fold roller 212.

<Threefold Processing>

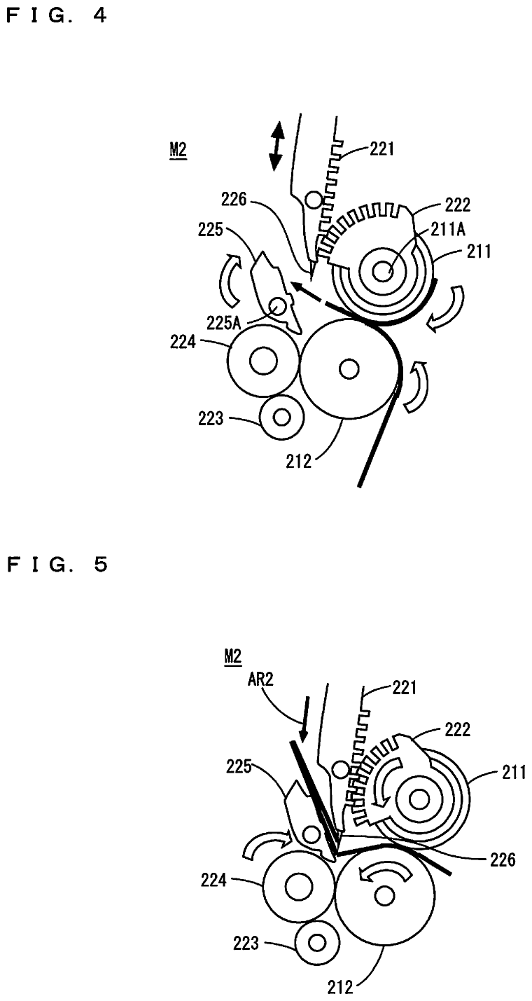

FIGS. 4 to 6 are diagrams for explaining the threefold processing performed by the second mechanism. FIGS. 4 to 6 are diagrams showing an enlarged region F of FIG. 3. With reference to FIGS. 4 to 6, the second mechanism M2 performs the threefold processing. The second mechanism M2 includes a threefold knife 221, a drive gear 222, a small threefold roller 223, a threefold roller 224, and a threefold gate 225 in addition to the first center-fold roller 211, the second center-fold roller 212, the center-fold knife 213, the auxiliary tray 214, the stacking tray 215, the stopper 216, and the positioning motor 217.

The threefold processing is a processing of folding a paper at two folding lines that trisect the paper. A processing of folding a paper at the first folding line is referred to as a first folding processing and a processing of folding a paper at the second folding line is referred to as a second folding processing. The first folding processing differs from the above-described center-fold processing only in position of the stopper and is the same as the above-described center-fold processing in the other operations. In the center-fold processing, the position of the stopper 216 is defined such that a distance between the stopper 216 and a position where the center-fold knife 213 is arranged is half a length of the paper conveying direction. In contrast, in the first folding processing, the position of the stopper 216 is defined such that the distance between the stopper 216 and the position where the center-fold knife 213 is arranged is one third the length of the paper conveying direction.

The threefold roller 224 is arranged opposite to the second center-fold roller 212. The threefold roller 224 has its rotation axis biased toward the rotation axis of the second center-fold roller 212.

The threefold knife 221 is arranged opposite to a threefold portion where the threefold roller 224 and the second center-fold roller 212 are in contact with each other. The threefold knife 221 is movable along the double-ended arrow shown in FIG. 4. A plurality of grooves are formed at equal spacing on a surface of the threefold knife 221 that faces the drive gear 222. The drive gear 222 is rotatably attached to a rotation axis 221A of the first center-fold roller 211 independently of the first center-fold roller 211. The drive gear 222 has a peripheral portion that is equally distanced from the rotation axis 221A. A gear that meshes with the plurality of grooves formed in the threefold knife 221 is formed in the peripheral portion. The stepping motor is driven, so that the drive gear 222 is rotated. With the rotation of the drive gear 222, the threefold knife 221 is movable along the double-ended arrow shown in FIG. 4. A position of the threefold knife 221 is defined by the stepping motor. In other words, a rotation angle of the stepping motor is controlled, so that the position of the threefold knife 221 is defined.

The threefold gate 225 is rotatable around the rotation axis 225A. The threefold gate 225 has an abutting surface. The threefold gate 225 is positioned at a position where the abutting surface is directed to the center-fold portion while the first folding processing is performed. A stack of papers conveyed from the center-fold portion where the first center-fold roller 211 and the second center-fold roller 212 are in contact with each other abuts against the abutting surface of the threefold gate 225.

By the first folding processing, as shown in FIG. 4, the stack of papers drawn in by the first center-fold roller 211 and the second center-fold roller 212 is conveyed with its mountain-folded portion set as the leading end toward the threefold gate 225 by the first center-fold roller 211 and the second center-fold roller 212. The leading end of the stack of papers abuts against the abutting surface of the threefold gate 225 and is then guided along the abutting surface.

With reference to FIG. 5, at a point in time when the first center-fold roller 211 and the second center-fold roller 212 are rotated by a predetermined rotation angle, the threefold knife 221 is moved toward the threefold portion as indicated by the arrow AR2. A time when the threefold knife 221 is moved is determined such that a tip of the threefold knife 221 abuts against the second folding lines of the papers. For example, a point in time when a predetermined time elapses after the center-fold knife 213 is moved toward the center fold portion is determined to be a time when the threefold knife 221 is moved. The predetermined time is defined based on a rotation speed of the first center-fold roller 211 and the second center-fold roller 212 and a paper size.

When the threefold knife 221 is moved toward the threefold portion as indicated by the arrow AR2, the second folding lines of the papers are pushed into the threefold portion by the threefold knife 221. Thus, the stack of papers is drawn in by the threefold roller 224 and the second center-fold roller 212 and is mountain-folded.

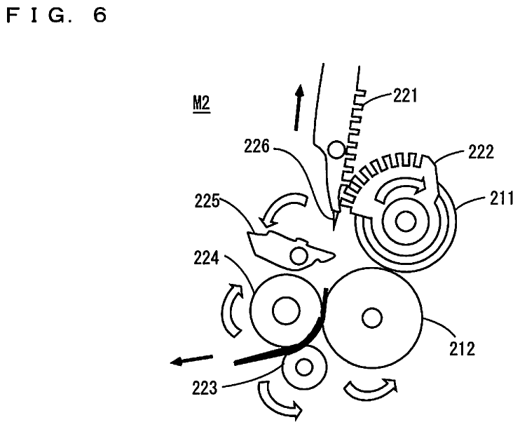

With reference to FIG. 6, the stack of papers mountain-folded by the threefold roller 224 and the second center-fold roller 212 is conveyed toward a portion between the threefold roller 224 and the small threefold roller 223 by the threefold roller 224 and the second center-fold roller 212 and is then discharged to the second discharge port 209.

<Z-Fold Processing>

With reference to FIG. 3, in a case where the Z-fold processing of Z-folding a paper is set, the paper discharged from the main body 101 of the MHP 100 enters the first conveying path R1 from the paper receiving port 201 and is conveyed to the first mechanism M1.

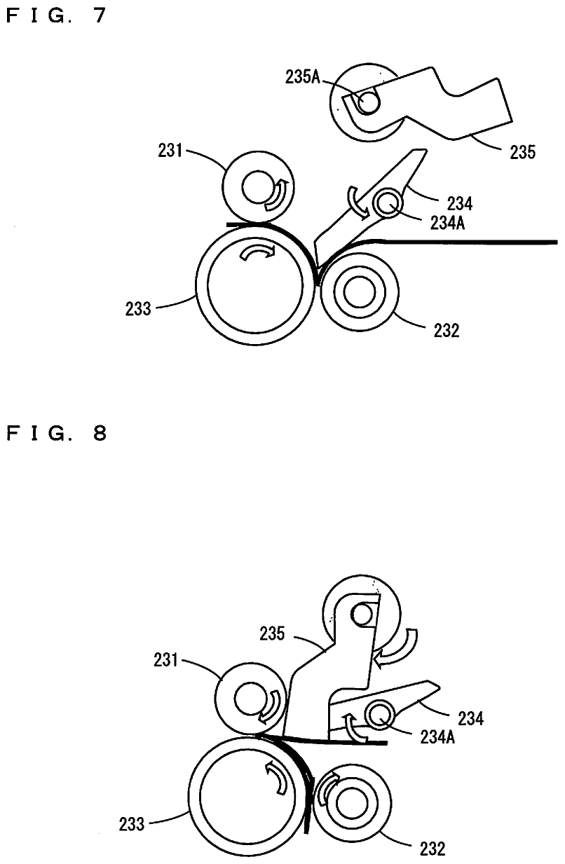

FIGS. 7 and 8 are diagrams for explaining the Z-fold processing performed by the first mechanism FIGS. 7 and 8 are diagrams showing the enlarged first mechanism M1. With reference to FIG. 7, the first mechanism M1 includes a first Z-fold roller 231, a second Z-fold roller 232, a third Z-fold roller 233, a folding claw 234, and a folding guide 235.

The first Z-fold roller 231, the second Z-fold roller 232, and the third Z-fold roller 233 have their rotation axes parallel to one another. The rotation axis of the second Z-fold roller 232 is biased to the rotation axis of the third Z-fold roller 233, and a first Z-fold portion where the second Z-fold roller 232 and the third Z-fold roller 233 are in contact with each other is formed. The rotation axis of the first Z-fold roller 231 is biased to the rotation axis of the third Z-fold roller 233, and a second Z-fold portion where the first Z-fold roller 231 and the third Z-fold roller 233 are in contact with each other is formed.

The folding claw 234 is attached to be rotatable around a rotation axis 234A above the second Z-fold roller 232. While being rotated, the folding claw 234 is movable to a retracting position where the folding claw 234 does not intersect with the first conveying path R1 and to a folding position where the folding claw 234 intersects with the first conveying path R1. In a case where the folding claw 234 is located at the folding position, a tip of the folding claw 234 is positioned between the second Z-fold roller 232 and the third Z-fold roller 233 as shown in FIG. 7.

The folding guide 235 is attached to be rotatable around a rotation axis 235A above the folding claw 234. While being rotated, the folding guide 235 is movable to a retracting position where the folding guide 235 does not overlap the folding craw 234 in side view and to a folding position that constitutes a part of an upper end of the first conveying path R1. With the folding guide 235 located at the folding position, the folding guide 235 has a restriction surface at its lower end. In a case where the folding guide 235 is located at the folding position, the restriction surface of the folding guide 235 constitutes a part of the upper end of the first conveying path R1. Also, an end of the restriction surface closer to the first Z-fold roller 231 is positioned between the first Z-fold roller 231 and the third Z-fold roller 233.

At a stage where a paper is conveyed through the first conveying path R1 from the paper receiving port 201, the folding guide 235 and the folding claw 234 are each located at the retracting position, and the third Z-fold roller 233 is rotated counterclockwise. The first Z-fold roller 231 is a driven roller and is rotated clockwise with the rotation of the third Z-fold roller 233. The paper conveyed through the first conveying path R1 is conveyed by the first Z-fold roller 231 and the third Z-fold roller 233.

At a point in time when the third Z-fold roller 233 is rotated by a predetermined rotation angle, the third Z-fold roller 233 is inversely driven and the folding claw 234 is moved to the folding position as shown in FIG. 7. A time when the third Z-fold roller 233 is inverted and a time when the folding claw 234 is moved are determined such that the tip of the folding claw 234 abuts against the first folding line of the paper. The time when the third Z-fold roller 233 is inverted and the time when the folding claw 234 is moved are determined based on a distance by which the third Z-fold roller 233 conveys the paper.

For example, a sensor that detects the paper is provided downstream of the third Z-fold roller 233 on the first conveying path R1. After the sensor detects the paper, a position of the paper is determined based on a rotation amount of the third Z-fold roller 233. Then, the time when the third Z-fold roller 233 is inverted and the time when the folding claw 234 is moved are determined based on the determined position of the paper and the rotation amount of the third Z-fold roller 233.

When the third Z-fold roller 233 is inverted, it is rotated clockwise. The second Z-fold roller 232 is a driven roller and is rotated counterclockwise with the rotation of the third Z-fold roller 233. The paper is pushed into the first Z-fold portion between the third Z-fold roller 233 and the second Z-fold roller 232 by the folding claw 234. Thus, the paper is drawn in by the third Z-fold roller 233 and the second Z-fold roller 232 and is valley-folded. The paper is conveyed by a predetermined distance by the third Z-fold roller 233 and the second Z-fold roller 232.

The distance by which the third Z-fold roller 233 and the second Z-fold roller 232 convey the paper corresponds to one third of the length of the paper conveying direction and is determined based on the rotation amount of the third Z-fold roller 233. For example, the distance by which the third Z-fold roller 233 and the second Z-fold roller 232 convey the paper may be determined by measuring an elapsed time after the third Z-fold roller 233 is inverted.

When the third Z-fold roller 233 and the second Z-fold roller 232 convey the paper by a predetermined distance, the third Z-fold roller 233 is inverted, and also the folding claw 234 is moved to the retracting position and the folding guide 235 is moved to the folding position. When the third Z-fold roller 233 is inverted, it is rotated counterclockwise, the second Z-fold roller 232 is rotated clockwise, and the first Z-fold roller 231 is rotated clockwise. A portion of the paper sandwiched between the third Z-fold roller 233 and the second Z-fold roller 232 is moved upward, and a rear end of the paper is conveyed in a downstream direction of the first conveying path R1. Therefore, a part of the paper abuts against the restriction surface of the folding guide 235. Thus, the paper is guided to the restriction surface of the folding guide 235 and is then pushed into the second Z-fold portion between the third Z-fold roller 233 and the first Z-fold roller 231. Thus, the paper is drawn in by the third Z-fold roller 233 and the first Z-fold roller 231 and is mountain-folded.

The paper is conveyed by the third Z-fold roller 233 and the first Z-fold roller 231 and is then discharged from the first discharge port 202 by the conveying roller pair 205 through the first conveying path R1.

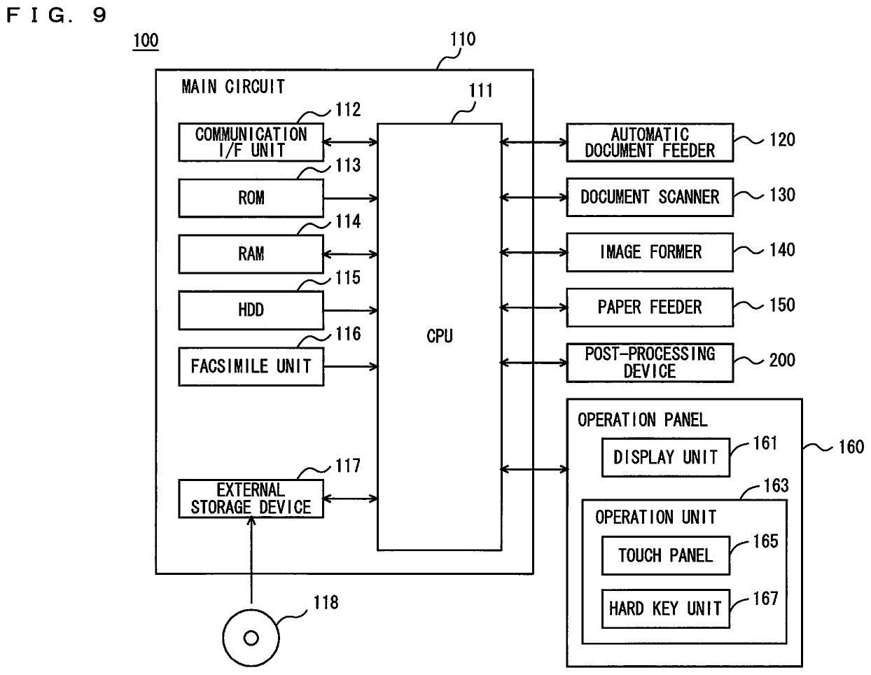

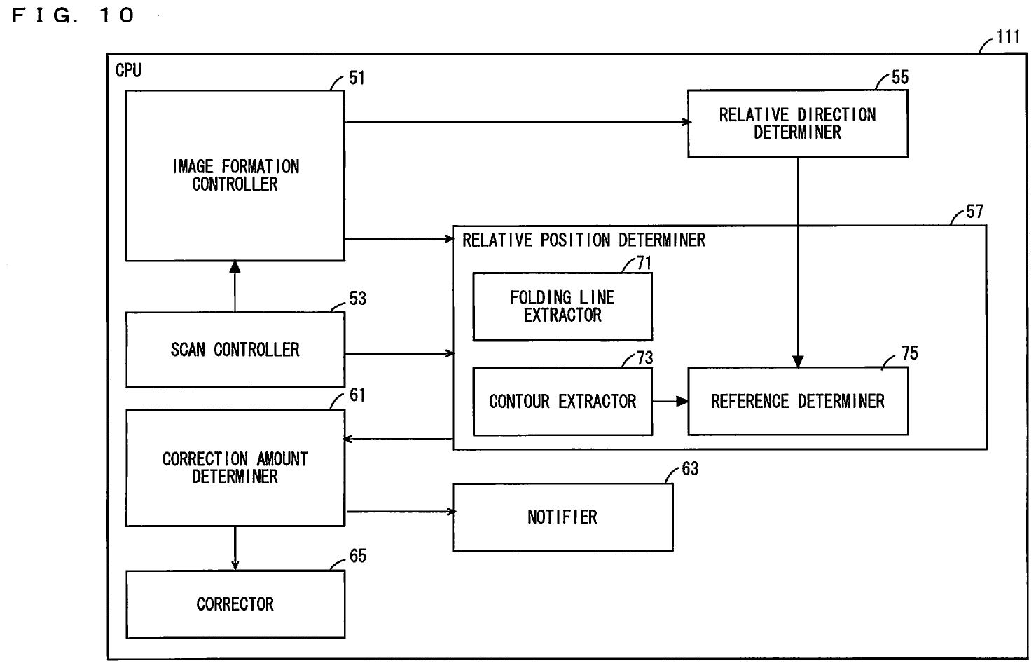

FIG. 9 is a block diagram showing the overview of the hardware configuration of the MFP. With reference to FIG. 9, the MFP 100 includes a main circuit 110. The main circuit 110 includes a CPU (Central Processing Unit) 111 for controlling the MFP 100 as a whole, a communication interface (I/F) unit 112, a ROM (Read Only Memory) 113, a RAM (Random Access Memory) 203, an EPROM (Erasable Programmable ROM) 114 that stores data in a nonvolatile manner, a Hard Disc Drive (HDD) 115 used as a mass storage device, a facsimile unit 116, and an external storage device 117. The CPU 111 is connected to the automatic document feeder 120, the document scanner 130, the image former 140, the paper feeder 150, the operation panel 160, and the post-processing device 200, and controls the MFP 100 as a whole.

The ROM 113 stores a program to be executed by the CPU 111 or data required for execution of the program. The RAM 114 is used as a work area when the CPU 111 executes the program. Further, the RAM 114 temporarily stores image data successively transmitted from the document scanner 130.

The operation panel 160 is provided on an upper surface of the MFP 100. The operation panel 160 includes a display unit 161 and an operation unit 163. The display unit 161 is a Liquid Crystal Display (LCD), for example, and displays an instruction menu for a user, information about acquired image data, etc. Alternatively, any device that displays an image, for example, an organic EL (electroluminescence) display may be used in place of the LCD.

The operation unit 163 includes a touch panel 165 and a hard key unit 167. The touch panel 165 is a capacitance type touch panel. The touch panel 165 is not limited to the capacitance type, and another type such as a resistive film type, a surface acoustic wave type, an infrared type and an electromagnetic induction type can be used.

The touch panel 165 is provided with its detection surface being overlaid on an upper surface or a lower surface of the display unit 161. Here, the size of the detection surface of the touch panel 165 and that of a display surface of the display unit 161 are the same. Therefore, a coordinate system of the display surface and that of the detection surface are the same. The touch panel 165 detects a position on the display surface of the display unit 161 designated by the user using the detection surface, and outputs a set of coordinates of the detected position to the CPU 111. Because the coordinate system of the display surface and that of the detection surface are the same, the set of coordinates output by the touch panel 165 can be replaced with the set of coordinates of the display surface.

The hard key unit 167 includes a plurality of hard keys. The hard keys are contact switches, for example. The touch panel 165 detects the position on the display surface of the display unit 161 designated by the user. In the case of operating the MFP 100, the user is likely to be in an upright attitude. Therefore, the display surface of the display unit 161, an operation surface of the touch panel 165, and the hard key unit 167 are arranged to face upward. This is for the purpose of enabling the user to easily view the display surface of the display unit 161 and easily provide an instruction on the operation unit 163 with his or her finger.

The communication I/F unit 112 is an interface for connecting the MFP 100 to a network. The communication I/F unit 112 communicates with another computer connected to the network using a communication protocol such as TCP (Transmission Control Protocol) or UDP (User Datagram Protocol). The network, to which the communication I/F unit 112 is connected is a Local Area Network (LAN) and may be either wired or wireless. Further, the network is not limited to the LAN but may be a Wide Area Network (WAN), a Public Switched Telephone Network (PSTN), the Internet or the like.

The facsimile unit 116 is connected to the Public Switched Telephone Network (PSTN), transmits facsimile data to the PSTN or receives facsimile data from the PSTN. The facsimile unit 116 stores the received facsimile data in the HDD 115, converts the facsimile data into print data that is printable in the image former 140, and outputs the print data to the image former 140. Thus, the image former 140 forms an image represented by the facsimile data received from the facsimile unit 116 on a paper. Further, the facsimile unit 116 converts the data stored in the HDD 115 into facsimile data and transmits the converted facsimile data to a facsimile machine connected to the PSTN.

The external storage device 117 is controlled by the CPU 111 and mounted with a CD-ROM (Compact Disk Read Only Memory) 118 or a semiconductor memory. While the CPU 111 executes a program stored in the ROM 113 by way of example in the present embodiment, the CPU 111 may control the external storage device 117 to read out a program to be executed by the CPU 111 from the CD-ROM 118 and store the read program in the RAM 114 for execution.

It is noted that a recording medium for storing the program executed by the CPU 111 is not limited to the CD-ROM 118. It may be a flexible disc, a cassette tape, an optical disc (MO (Magnetic Optical Disc)/MD (Mini Disc)/DVD (Digital Versatile Disc)), an IC card, an optical card, and a semiconductor memory such as a mask ROM and an EPROM (Erasable Programmable ROM).

Further, the CPU 111 may download a program from a computer connected to the network to store the program in the HDD 115, or the computer connected to the network may write the program in the HDD 115. Then, the program stored in the HDD 115 may be loaded into the RAM 114 to be executed by the CPU 111. The program referred to here includes not only a program directly executable by the CPU 111 but also a source program, a compressed program, an encrypted program and the like.

FIG. 10 is a block diagram showing one example of functions of the CPU included in the MFP. The functions of the CPU 111 included in the MFP 100 are implemented by the CPU 111 executing a post-processing position adjusting program stored in the ROM 113, the HDD 115 or the CD-ROM 118. With reference to FIG. 10, the CPU 111 includes an image formation controller 51, a scan controller 53, a relative direction determiner 55, a relative position determiner 57, a correction amount determiner 61, a notifier 63, and a corrector 65.

The scan controller 53 controls the document scanner 130 to scan an image formed on a document. The scan controller 53 outputs data obtained by scanning the document as scan data to the relative position determiner 57.

The scan controller 53 controls the document scanner 130 to scan the document in either a normal mode or a folding line detection mode. In a case where the scan controller 53 causes the document scanner 130 to scan the document in the normal mode, the scan controller 53 makes the document scanner 130 scan the document with one or both of the exposure lamps 13A, 13B emitting light, and acquires image data output by the CCD sensor 18 as document data. The scan controller 53 outputs the document data to the image formation controller 51 and the relative position determiner 57.

In a case where the scan controller 53 causes the document scanner 130 to scan the document in the folding line detection mode, the scan controller 53 makes the document scanner 130 scan the document with either one of the exposure lamps 13A, 13B emitting light, and acquires first image data output by the CCD sensor 18. The scan controller 53 subsequently makes the document scanner 130 scan the document with the other of the exposure lamps 13A, 13B emitting light, and acquires second image data output by the CCD sensor 18. In the case where the scan controller 53 causes the document scanner 130 to scan the document in the folding line detection mode, the scan controller 53 makes the document scanner 130 scan a region that includes a contour of the document. The scan controller 53 outputs the first image data and the second image data as scan data to the relative position determiner 57. A first incidence angle at which the light emitted from the exposure lamp 13A is incident on the document and a second incidence angle at which the light emitted from the exposure lamp 13B is incident on the document are different from each other. As such, in a case where there is a folding line that intersects with the sub-scanning direction, a change in brightness before and after the folding line is different between the first image data and the second image data.

The image formation controller 51 controls the image former 140 and the paper feeder 150 to perform an image formation processing of forming an image on a paper, and controls the post-processing device 200 to perform a post-processing of processing the paper with the image formed thereon. The post-processing includes the center-fold processing, the threefold processing, and the Z-fold processing. The image formation controller 51 forms an image of formation data on a paper. The formation data includes document data obtained by scanning a document by the scan controller 53, print data received from outside, and image data stored in the HDD 115. The image formation controller 51 outputs paper information as to the paper with the image formed thereon to the relative direction determiner 55. The paper information includes a size of a paper, a paper conveying direction, and an image forming direction. The conveying direction refers to either a longer direction or a shorter direction of a paper. For example, in a case where a paper is conveyed with its longer direction being parallel to the conveying direction, the conveying direction refers to the longer direction. In a case where the paper is conveyed with its shorter direction being parallel to the conveying direction, the conveying direction refers to the shorter direction. The image forming direction refers to a direction of an image formed on the paper and refers to either a longitudinal direction or a lateral direction. A top and a bottom of an image of formation data are determined. In a case where the image is formed on the paper with its longer direction being parallel to a top-and-bottom direction of the image, the image forming direction refers to the longitudinal direction. In a case where the image is formed on the paper with its shorter direction being parallel to the top-and-bottom direction of the image, the image forming direction refers to the lateral direction. Also, the image formation controller 51 outputs formation data to the relative position determiner 57.

The relative direction determiner 55 determines a relative direction defined by the direction of the image formed on the paper and the direction of the paper. Here, the relative direction is a direction in which the leading end of the paper in the paper conveying direction is positioned with respect to the direction of the image formed on the paper. In other words, the relative direction refers to any of the top, bottom, left, and right of the image formed on the paper. The relative direction determiner 55 determines the relative direction based on paper information.

The relative direction determiner 55 determines the relative direction from the paper conveying direction and the image forming direction. Specifically, in a case where the paper conveying direction is the longer direction and the image forming direction is the longitudinal direction, the relative direction determiner 55 determines a top side of the image as the relative direction. In a case where the paper conveying direction is the longer direction and the image forming direction is the lateral direction, the relative direction determiner 55 determines a left side of the image as the relative direction. Also, in a case where the paper conveying direction is the shorter direction and the image forming direction is the longitudinal direction, the relative direction determiner 55 determines the top side of the image as the relative direction. In a case where the paper conveying direction is the longer direction and the image forming direction is the lateral direction, the relative direction determiner 55 determines the left side of the image as the relative direction.

The relative position determiner 57 analyzes scan data and determines a reference side in the scan data. The relative position determiner 57 includes a folding line extractor 71, a contour extractor 73, and a reference determiner 75.

The folding line extractor 71 analyzes scan data and extracts a folding line. The scan data includes first image data and second image data. A change in brightness before and after the folding line is different between the first image data and the second image data in the sub-scanning direction. The folding line is a straight line intersecting with the sub-scanning direction. For example, the folding line extractor 71 generates synthetic data in which a value of a pixel at a same position in each of the first image data and the second image data is set to a lower brightness value and difference data composed of pixels which have a brightness difference equal to or more than a predetermined value between the first image data and the second image data. The folding line is extracted from either the synthetic data or the difference data. The folding line extractor 71 specifies as the folding line a set of a plurality of pixels constituting a straight line among pixels with a brightness value equal to or more than a predetermined brightness value in the synthetic data. The folding line extractor 71 also specifies as the folding line a set of a plurality of pixels constituting a straight line among pixels which have a brightness difference equal to or less than a predetermine value and are positioned among pixels with different brightness in the difference data.

FIG. 11 is a diagram showing one example of synthetic data. The synthetic data shown in FIG. 11 indicates synthetic data generated from first image data and second image data obtained by scanning an unfolded paper such that an inner side of the paper subjected to the center-fold processing is a scanning surface. With reference to FIG. 11, a contour of the paper is expressed as a rectangular shape in the synthetic data.

Also, the light emitted from each of the exposure lamps 13A, 13B does not reach a valley-folded portion in some cases. In such cases, the valley-folded portion is represented as pixels with lower brightness in the synthetic data generated from the first image data and the second image data. In the portion with lower brightness in the synthetic data, a set of pixels constituting a straight line with a predetermined length is extracted as the folding line.

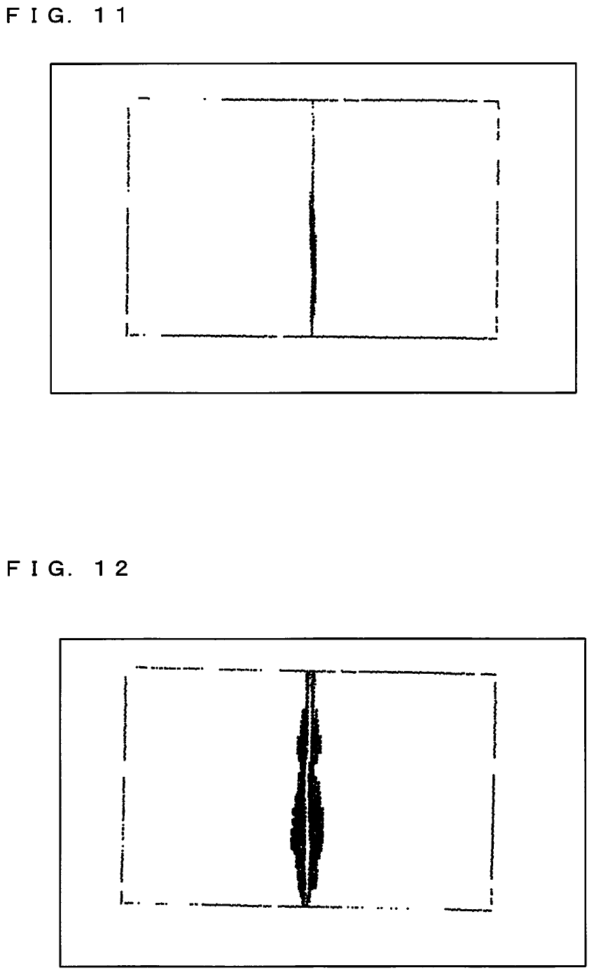

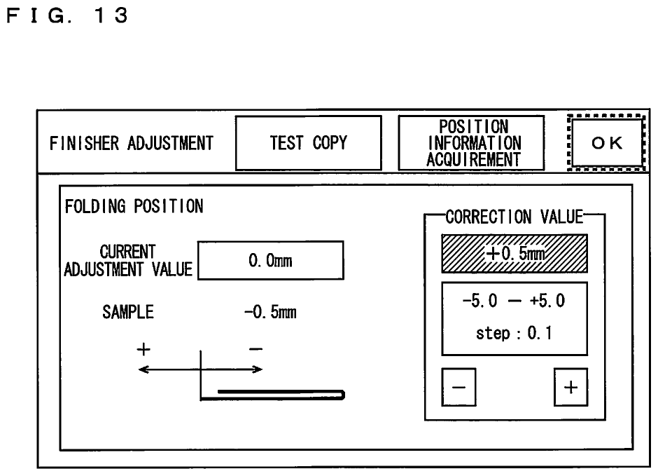

FIG. 12 is a diagram showing one example of difference data. The difference data shown in FIG. 12 indicates difference data generated from first image data and second image data obtained by scanning an unfolded paper such that an outer side of the paper subjected to the center-fold processing is a scanning surface. With reference to FIG. 12, a contour of the paper is expressed as a rectangular shape in the difference data.

Also, opposite sides of a mountain-folded line include a portion where the light emitted from either one of the exposure lamps 13A, 13B reaches, but the light emitted from the other exposure lamp does not reach. As such, the difference data generated from the first image data and the second image data includes pixels which have a difference in pixel value between the first image data and the second image data and pixels whose difference in pixel value is less than a predetermined value. In the difference data, a set of pixels which have a brightness difference less than a predetermined value, are sandwiched between sets of pixels having a brightness difference equal to or more than the predetermined value, and constitute a straight line with a predetermined length is extracted as the folding line.

Returning to FIG. 10, the contour extractor 73 analyzes scan data and extracts a contour portion of a paper. In the scan data, the contour of the paper is expressed in at least one of the first image data and the second image data. The contour portion of the paper has a rectangular shape. For example, the contour extractor 73 generates synthetic data in which a pixel value of a pixel at a same position in each of the first image data and the second image data is set to a smaller pixel value, and extracts a rectangular portion with a pixel value equal to or less than a predetermined value as the contour portion in the synthetic data. Also, the contour extractor 73 may extract a rectangular shape surrounding a portion of the synthetic data that coincides with formation data input from the image formation controller 51.

The reference determiner 75 determines as a reference side a side that is positioned in a relative direction determined by the relative direction determiner 55 among four sides of the contour portion in the scan data. First, the reference determiner 75 determines a direction of the contour portion from a direction of a portion of the scan data that coincides with the formation data. Since the top, bottom, left, and right of an image of the formation data are defined, the top, bottom, left, and right of an image of the scan data are defined. Then, the reference determiner 75 determines as the reference side the side that is positioned in the relative direction determined by the relative direction determiner 55 among the four sides constituting the contour portion in the scan data. Thus, among the four sides constituting the contour portion in the scan data, the side corresponding to a side of the leading end of the paper in the paper conveying direction is determined as the reference side.

A relative position of the folding line to the paper is input from the relative position determiner 57 to the correction amount determiner 61. The correction amount determiner 61 determines a correction amount based on the relative position. The correction amount determiner 61 compares the relative position with a prescribed value that is predetermined with respect to the paper and determines a difference between the relative position and the prescribed value as a correction amount. When the center-fold processing is preformed, half of the length of the paper in the paper conveying direction is defined as a prescribed value. When the threefold processing or the Z-fold processing is preformed, one third of the length of the paper in the paper conveying direction is predetermined as a prescribed value. A value obtained by subtracting the prescribed value from the relative position is determined as a correction amount. The correction amount determiner 61 outputs the determined correction amount to the notifier 63 and the corrector 65.

The notifier 63 notifies a user of the correction amount determined by the correction amount determiner 61. For example, a correction amount adjustment screen is displayed on the display unit 161. The correction amount adjustment screen includes the correction amount.

The corrector 65 adjusts the post-processing device 200 based on the correction amount determined by the correction amount determiner 61. Specifically, when the correction amount is a value with respect to the center-fold processing, the corrector 65 changes the position of the stopper 216 by the correction amount. When the correction amount is a value with respect to the threefold processing, the corrector 65 changes the position of the stopper 216 by the correction amount and also changes a time when the threefold knife 221 is driven by a period of time corresponding to the correction amount. When the correction amount is a value with respect to the Z-fold processing, the corrector 65 changes a time when the third Z-fold roller 233 is inverted the first time and a time when the folding claw 234 is moved to the folding position by a period of time corresponding to the correction amount, and also changes a time when the third Z-fold roller 233 is inverted the second time and a time when the folding guide 235 is moved to the folding position by a period of time corresponding to the correction amount.

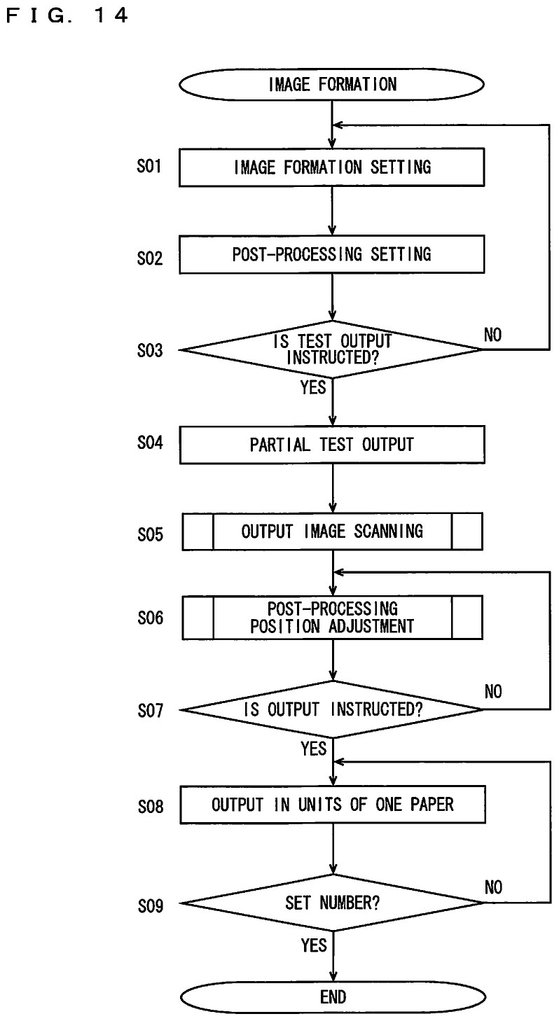

FIG. 13 is a diagram showing one example of the correction amount adjustment screen. With reference to FIG. 13, the correction amount adjustment screen includes a current adjustment value, a sample, a correction value. The current adjustment value indicates a difference from a reference value. Here, the current adjustment value is indicated to be 0.0 mm. The sample indicates a difference between an actual folding line position and a predetermined folding line position. Here, the sample is indicated to be −0.5 mm. The actual folding line position is indicated by a distance between a folding line detected from scan data and a reference side. The predetermined folding line position refers to an ideal folding line defined with respect to a paper and is indicated by a distance between the folding line and the reference side. The predetermined folding line position is predetermined with respect to the size of the paper and the paper conveying direction. The correction value indicates a correction amount with respect to a set value that is set for the post-processing device 200. Here, the correction value is indicated to be +0.5 mm. The correction amount is a value defined based on the sample. Thus, a user is notified that the set value set for the post-processing device 200 is indicated to be corrected by the correction value and corrected such that the difference between the folding line and the ideal folding line is zero. In a field where the correction value is displayed, a + button and a − button are shown and thus the user can change the correction value. When an OK button is designated after the correction value is changed by operation of the + button and the − button, the set value set for the post-processing device 200 is corrected by the changed correction value.

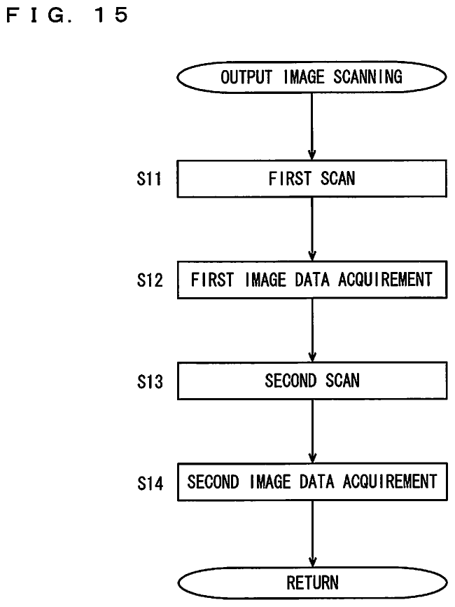

FIG. 14 is a flowchart showing one example of a flow of the image forming processing. The image forming processing is a processing executed by the CPU 111 included in the MFP 100 executing a post-processing position adjusting program stored in the ROM 113, the HDD 115 or the CD-ROM 118. With reference to FIG. 14, the CPU 111 receives an image formation setting (step S01) and proceeds the processing to step S02. A setting that is input to the operation panel 160 by the user to cause the image former 140 to form an image is received. The setting for causing the image former 140 to form the image includes a size of a paper, a paper conveying direction, and an image forming direction. In a case where the document scanner 130 is caused to scan a document, a setting for causing the document scanner 130 to scan the document is also received.

A post-processing setting is received in step S02, and the processing proceeds to step S03. A setting that is input to the operation panel 160 by the user to cause the post-processing device 200 to perform a post-processing is received. The post-processing includes a folding processing. The folding processing includes any of the center-fold processing, the threefold processing, and the Z-fold processing. Whether a test output instruction is received is determined in step S03. In a case where the user inputs the test output instruction to the operation panel, it is determined that the test output instruction is received. If the test output instruction is received, the processing proceeds to step S04. If not, the processing returns to step S01. Step S01 and step S02 may be executed in reverse order or may be executed simultaneously.

In step S04, partial test output is performed, and the processing proceeds to step S05. The CPU 111 controls the image former 140 to form an image on one paper in accordance with the image formation setting set in step S01, and causes the post-processing device 200 to execute a post-processing in accordance with the post-processing setting set in step S02. Even in a case where image formation is set for a plurality of papers in the image formation setting, the CPU 111 causes the image former 140 to form an image on only one paper and causes the post-processing device 200 to execute the post-processing.

An output image scanning processing is executed in step S05, and the processing proceeds to step S06. The paper that is output after being subjected to the image formation processing and the post-processing in step S04 has a folding line. When the user presses a start button after placing the paper unfolded on the document glass 11, the output image scanning processing is executed. A post-processing position adjustment processing is executed in step S06, and the processing proceeds to step S07. While the output image scanning processing and the post-processing position adjustment processing are described in detail below, these processings are a processing of scanning the paper test-output in step S04 and a processing of determining a correction amount for adjusting a post-processing position, respectively.

Whether an output instruction is received is determined in step S07. The output instruction input to the operation panel 160 by the user is received. If the test output instruction is received, the processing proceeds to step S08. If not, the processing returns to step S06.

The paper is output in units of one paper in step S08, and the processing proceeds to step S09. The CPU 111 controls the image former 140 to form an image on the paper in accordance with the image formation setting set in step S01, and causes the post-processing device 200 to execute a post-processing in accordance with the post-processing setting set in step S02. In step S09, whether the number of papers on which the image is formed is equal to a set number is determined in step S09. If the number of papers of image formation becomes equal to the set number, then the processing ends. If not, the processing returns to step S08.

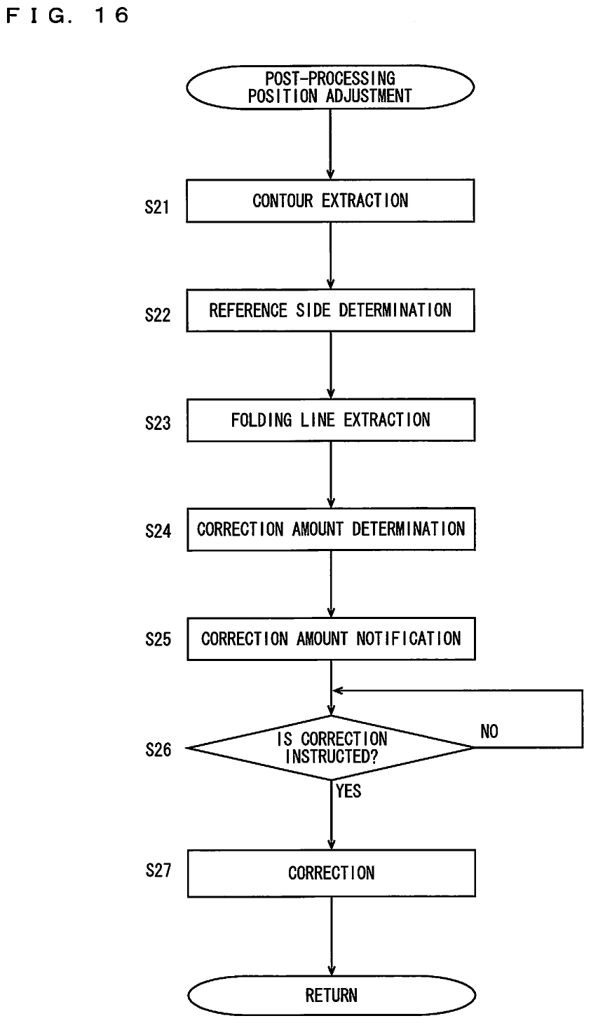

FIG. 15 is a flowchart showing one example of a flow of the output image scanning processing. The output image scanning processing is a processing executed in step S05 of the image forming processing. The unfolded test-output paper is placed on the document glass 11 by the user at a stage before the output image scanning processing is executed.

With reference to FIG. 15, the CPU 111 executes a first scan (step S11), and proceeds the processing to step S12. The CPU 111 causes the exposure lamp 13A to expose and scan the document. At that time, a region that is larger in the sub-scanning direction and the main scanning direction than the size of the document is scanned. In step S12, first image data is acquired. The exposure lamp 13A scans the document, light reflected from the document is received at the CCD sensor 18, and the first image data output by the CCD sensor 18 is acquired.

In subsequent step S13, a second scan is executed, and the processing proceeds to step S14. The CPU 111 causes the exposure lamp 13B to expose and scan the document. At that time, a region that is larger in the sub-scanning direction and the main scanning direction than the size of the document is scanned. In step S14, second image data is acquired, and the processing returns to the image formation processing. The exposure lamp 13B scans the document, light reflected from the document is received at the CCD sensor 18, and the second image data output by the CCD sensor 18 is acquired.

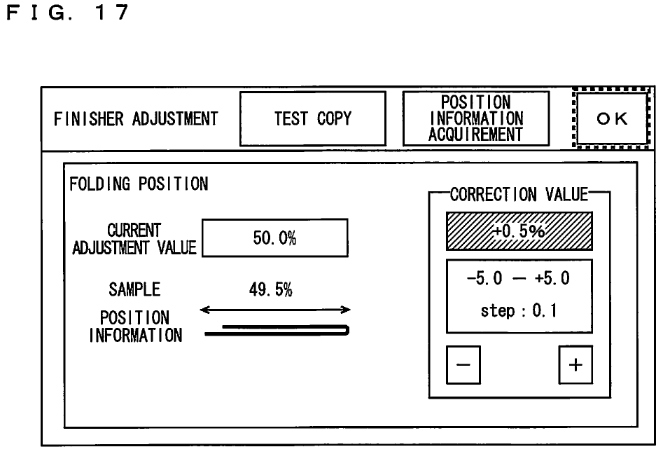

FIG. 16 is a flowchart showing one example of a flow of the post-processing position adjustment processing. The post-processing position adjustment processing is a processing executed in step S06 of the image formation processing. The first image data and the second image data are acquired at a stage before the post-processing position adjustment processing is executed.

With reference to FIG. 16, the CPU 111 extracts a contour from each of the first image data and the second image data (step S21), and proceeds the processing to step S22. Synthetic data in which a value of a pixel at a same position in each of the first image data and the second image data is set to a lower brightness value, and a rectangular contour portion is extracted from the synthetic data. A rectangular portion with a pixel value equal to or less than a predetermined value in the synthetic data is extracted as the contour portion. Also, a portion of the synthetic data that coincides with formation data to be a basis of the image formed on the paper may be extracted, and a rectangular shape surrounding the extracted portion may be extracted as the contour portion.

In step S22, one reference side is determined among four sides of the contour portion, and the processing proceeds to step S32. Among the four sides constituting the contour portion, the side of the leading end of the paper in the paper conveying direction is determined as the reference side. A direction of the contour portion is determined from a direction of the portion of the synthetic data that coincides with the formation data. Then, the reference side is determined from the paper conveying direction and the image forming direction.

In step S23, a folding line is extracted, and the processing proceeds to step S24. Synthetic data in which the value of a pixel at a same position in each of the first image data and the second image data is set to a lower brightness value and difference data composed of pixels which have a brightness difference equal to or more than a predetermined value between the first image data and the second image data are generated. The folding line is extracted from either the synthetic data or the difference data. A set of a plurality of pixels constituting a straight line among pixels with a brightness value equal to or less than a predetermine brightness value in the synthetic data is extracted as the folding line. Also, a set of a plurality of pixels constituting a straight line among pixels which have brightness differences equal to or less than a predetermine value and are positioned among pixels with different brightness in the difference data is extracted as the folding line.

In step S24, a correction amount is determined. A distance between the reference side determined in step S22 and the folding line determined in step S23 is compared with a prescribed value. A difference between the prescribed value and the distance between the reference side and the folding line is determined as the correction amount. The prescribed value refers to a distance between an ideal folding line defined with respect to the paper and the side of the leading end of the paper in the paper conveying direction, and is predetermined with respect to the size of the paper and the paper conveying direction.

In step S25, the correction amount is notified, and the processing proceeds to step S26. For example, the correction amount adjustment screen shown in FIG. 13 is displayed on the display unit 161. Whether a correction instruction is received is determined in step S26. In response to the OK button of the correction amount adjustment screen instructed by the user, the correction instruction is received. The CPU 111 waits until the correction instruction is received (NO in step S26). If the correction instruction is received (YES in step S26), the processing proceeds to step S27.

In step S27, a set value of the post-processing device 200 is corrected in accordance with the correction amount, and the processing ends.

<Modification of Correction Amount Adjustment Screen>

FIG. 17 is a diagram showing one example of the correction amount adjustment screen in a modification. With reference to FIG. 17, the correction amount adjustment screen in the modification is different from that shown in FIG. 13 in units of value displayed. The unit of the correction amount adjustment screen in the modification is percentage (%). This is the proportion of the distance of the folding line from the reference side to the length of the paper in the paper conveying direction. In FIG. 17, the current adjustment value is indicated to be 50%. The sample indicates the proportion of the distance between the actual folding line and the reference side to the length of the paper and is indicated to be 49.5%. The correction value indicates a correction amount with respect to a set value that is set for the post-processing device 200. Here, +0.5% is indicated. Thus, a user is notified that the set value set for the post-processing device 200 is indicated to be corrected by the correction value and corrected such that the difference between the folding line and the ideal folding line is zero.

As described above, the MFP 100 in the present embodiment functions as the image forming apparatus, includes the post-processing device 200 that folds the paper on which the image is formed, acquires the scan data output by scanning the region including the contour of the document folded by the post-processing device 200, and determines the relative position of the contour of the document and the folding line based on the scan data. Therefore, since the position of the folding line is determined based on the contour of the document in the scan data, the position of the folding line is determined irrespective of the position where the document is placed at the point in time when the document is scanned. Thus, the position of the folding line formed in the document can be accurately detected.

Moreover, the MFP 100 extracts the folding line and the contour of the document based on the first image data obtained by receiving the light, which is emitted to the document, incident on the document at a first incidence angle, and then reflected from the document and the second image data obtained by receiving the light, which is emitted to the document, incident on the document at a second incidence angle, and then reflected from the document. Since the first incidence angle and the second incidence angle are different from each other, regions with different pixel values between the first image data and the second image data in the region surrounding the folding line of the document can be detected. Thus, the folding line of the document in the image data can be accurately detected.

Furthermore, the MFP 100 determines the correction amount of the set value set in the post-processing device 200 based on the relative position of the contour and the folding line of the document. As such, the correction amount can be easily determined from a deviation amount of the folding line.

Moreover, since the MFP 100 displays the correction amount adjustment screen including the correction amount on the display unit 161, the user can be notified of the correction amount and can confirm the correction amount by viewing the correction amount adjustment screen.

Furthermore, the MFP 100 corrects the set value set in the post-processing device 200 using the correction amount. Therefore, the MFP 100 can automatically correct the set value of the post-processing device 200.

Moreover, since the MFP 100 notifies the correction amount in units of length, the user can identify the correction amount by length.

Also, since the MFP 100 in the modification notifies the correction amount in units of ratio, the MFP 100 can notify the correction amount on the same basis with respect to a plurality of paper sizes.

Also, the MFP 100 determines the reference side that defines the relative position of the folding line among the four sides of the document, on which the image is formed on the paper, based on the paper conveying direction when the image is formed on the paper and the image forming direction. Therefore, the reference side can be determined from the scan data obtained by scanning the paper, on which the image is formed, as the document.

Although embodiments of the present invention have been described and illustrated in detail, the disclosed embodiments are made for purpose of illustration and example only and not limitation. The scope of the present invention should be interpreted by terms of the appended claims

What is claimed is:

1. An image forming apparatus comprising:
a post-processing device that folds a paper on which an image is formed;
a document scanner that scans a document; and
a hardware processor,
wherein the hardware processor acquires image data output by the document scanner scanning a region that includes a contour of the document with a folding line formed by being folded by the post-processing device, and
determines a relative position of the contour and the folding line of the document based on the image data.

2. The image forming apparatus according to claim 1, wherein the document scanner includes
a first light emitter that emits light to the document at a first incidence angle,
a second light emitter that emits light to the document at a second incidence angle different from the first incidence angle, and
a light receiver that receives the lights emitted by the first light emitter and the second light emitter, and
the hardware processor extracts the folding line and the contour of the document based on first image data output by the light receiver receiving the light emitted by the first light emitter and second image data output by the light receiver receiving the light emitted by the second light emitter.

3. The image forming apparatus according to claim 1, wherein the hardware processor further determines a correction amount of a set value that is set in the post-processing device based on the relative position of the contour and the folding line of the document.

4. The image forming apparatus according to claim 3, wherein the hardware processor notifies the correction amount.

5. The image forming apparatus according to claim 3, wherein the hardware processor corrects the set value that is set in the post-processing device using the correction amount.

6. The image forming apparatus according to claim 3, wherein a unit of the correction amount is length.

7. The image forming apparatus according to claim 3, wherein the unit of the correction amount is ratio.

8. The image forming apparatus according to claim 1, further comprising
an image former that forms the image on the paper to output the document,
wherein the hardware processor acquires a relative direction indicating a relative direction of the image to the document based on a relative direction of the paper and the image when the image former outputs the document.

9. A post-processing position adjusting method performed by an image forming apparatus including a post-processing device that folds a paper on which an image is formed, the image forming apparatus further including a document scanner that scans a document,
the method comprising:
a scan controlling step of acquiring image data output by the document scanner scanning a region that includes a contour of the document with a folding line formed by being folded by the post-processing device; and
a relative position determining step of determining a relative position of the contour and the folding line of the document based on the image data.

10. The post-processing position adjusting method according to claim 9, wherein the document scanner includes
a first light emitter that emits light to the document at a first incidence angle,
a second light emitter that emits light to the document at a second incidence angle different from the first incidence angle, and
a light receiver that receives the lights emitted by the first light emitter and the second light emitter, and
the relative position determining step includes a step of extracting the folding line and the contour of the document based on first image data output by the light receiver receiving the light emitted by the first light emitter and second image data output by the light receiver receiving the light emitted by the second light emitter.

11. The post-processing position adjusting method according to claim 9, further comprising a determining step of determining a correction amount of a set value that is set in the post-processing device based on the relative position of the contour and the folding line of the document.

12. The post-processing position adjusting method according to claim 11, further comprising a notifying step of notifying the correction amount.

13. The post-processing position adjusting method according to claim 11, further comprising a correcting step of correcting the set value set in the post-processing device using the correction amount.

14. The post-processing position adjusting method according to claim 11, wherein a unit of the correction amount is length.

15. The post-processing position adjusting method according to claim 11, wherein the unit of the correction amount is ratio.

16. The post-processing position adjusting method according to claim 9, wherein the image forming apparatus further includes an image former that forms the image on the paper to output the document,
the method further comprising a relative direction acquiring step of acquiring a relative direction indicating a relative direction of the image to the document based on a relative direction of the paper and the image when the image former outputs the document.

17. A non-transitory computer-readable recording medium encoded with a post-processing position adjusting program executed by a computer that controls an image forming apparatus that includes a post-processing device that folds a paper on which an image is formed,
the image forming apparatus further including a document scanner that scans a document,
the post-processing position adjusting program causing the computer to execute:
a scan controlling step of acquiring image data output by the document scanner scanning a region that includes a contour of the document with a folding line formed by being folded by the post-processing device; and
a relative position determining step of determining a relative position of the contour and the folding line of the document based on the image data.
